(19) United States
(12) Patent Application Publication
(10) Pub. No.: US 2009/0049388 A1
(43) Pub. Date: Feb. 19, 2009

(54) MULTIMODAL COMPUTER NAVIGATION

(76) Inventors: Ronnie Bernard Francis Taib, New South Wales (AU); Fang Chen, New South Wales (AU); Yu Shi, New South Wales (AU)

Correspondence Address: SNELL & WILMER LLP (OC), 600 ANTON BOULEVARD, SUITE 1400, COSTA MESA, CA, 92626, US

(21) Appl. No.: 11/916,255

(22) PCT Filed: Jun. 2, 2006
(86) PCT No.: PCT/AU2006/000753

§ 371 Date: May 30, 2008

(30) Foreign Application Priority Data
Jun. 2, 2005 (AU) 2005902861

(51) Int. Cl. G06F 3/00

(52) U.S. Cl. 715/738

(57) ABSTRACT

This invention concerns multimodal computer navigation, that is operation of a computer using traditional modes such as keyboard together with less conventional modes such as speech and gestures. The invention has particular application for navigation of information presentations, such as webpages and database user interfaces, and is presented as a method, a browser, software and a computer system. The information navigated is not described in a multimodal way. Two or more unimodal navigation signals are received from a user and interpreted. These interpretations are fused to automatically determining the user's intended navigation selection.

### TECHNICAL FIELD

This invention concerns multimodal computer navigation, that is operation of a computer using traditional modes such as keyboard together with less conventional modes such as speech and gesturing. The invention has particular application for navigation of information presentations, such as webpages, and is presented as a method, a browser, software and a computer system.

### BACKGROUND ART

Traditionally, computer users have relied on conventional input devices such as keyboard, touch-screen and mouse to navigate through information presented on a display device of the computer. The information may be presented in a variety of interfaces such as web browsers or application front-end presentation layers to say a database. Recent initiatives, such as speech recognition, have provided limited enhancements to this process, by providing to the user an alternative method of interacting with applications. However, these enhancements are usually no more than slightly more exotic unimodal replacements for an existing input mode.

Multimodal navigation has been described using speech plus keyboard, and speech plus GUI output. The multimodal input is received and coded into multimodal mark-up language in which each different type of input is tagged with a multimodal tag so that it can be subsequently interpreted. In addition the information to be browsed is also tagged with multimodal tags to enable the multimodal navigation. The inventors have termed this approach to multimodal navigation “early binding”.

### SUMMARY OF THE INVENTION

The invention is a method for multimodal computer navigation, suitable for navigating information presentations where the information navigated is not described in a multimodal way; the method comprising the steps of:

receiving unimodal navigation signals from a user;

receiving other unimodal navigation signals from the user;

interpreting the navigation signals;

interpreting the other navigation signals; and

automatically determining the user's intended navigation selection from a fusion of both interpretations.

The invention is described by the inventors as requiring a “late binding” multimodal interpretation since the information browsed does not need to be described in a multimodal way. In this way, the use of multimodal navigation does not have to be pre-coded (i.e. hard coded) into the information being presented. The fusion is intended to lead to an improvement over current techniques. For instance fusing may be quicker than using multiple unimodal input events each of which results in a small navigation advance leading stepwise to a selection. Fusing may also be quicker than a longer unimodal input events such as a mouse advance over a large distance to the desired selection.

One of the unimodal navigation signals may be generated from a conventional input device. In contrast the other unimodal navigation signals may be generated from speech or a body gesture.

“Interpreting” each of the navigation signals involves electronically decoding the input to determine the navigational meaning of that input. This may utilise conventional processing where the signal is generated using a conventional input device. It may even involve the use interpretation of a multimodal mark-up language.

Conventional input devices may include speech recognition software, keyboard, touch-screen, writing tablet, joystick, mouse or touch pad.

The body gestures may include movements of the head, hand and other body parts such as eyes. These gestures may be captured by analysing video, or from motion transducers worn by the user.

Predefined fusions of unimodal signals that form a navigation selection may be created, and the user trained in their use. Personal or task oriented profiles may be created for particular users or tasks.

The possible navigation selections that could be selected by the user for the information presentation are determined once or during when an information presentation is processed. This may be repeated for every information presentation that is displayed to the user.

The information presentation may be a graphical display of information and the user's selected navigation is either navigation of the entire display or of a smaller information presentation within the information presentation.

The invention may be extended through learning and adapting as it is used by a particular user.

Fusion of multimodal inputs can improve navigation through disambiguation or semantic redundancy. Consequently, the multimodal interactions when fused can result in complex tasks being completed by a single turn of dialogue; which is impossible with current unimodal methods.

The fusion may involve generating some combination of the interpretations, and a combination signal resulting from the fusion may then be used to make the automatic determination.

Alternatively, the fusion may involve sequential consideration of interpretations of transducer generated and body gesture navigation signals. Where the interpretations are considered sequentially, the computer may respond to an earlier inconclusive interpretation in some way, perhaps by changing the display, before receiving or taking account of later interpretations.

One way the computer may respond to an earlier ambiguous interpretation is to create scattered islands, or tabs, related to respective of the inconclusive interpretations. Coarse inputs, such as gestures, can then be interpreted to select one of the scattered islands, and therefore make an unambiguous selection.

It is greatly preferred in all cases that one of the unimodal navigation signals will be body gesture information.

Gesture recognition software modules may be employed to analyse the video or motion transducer signals and interpret the gestures. Vocabularies of gestures may be built up to speed recognition, and personal or task oriented profiles may be created for particular users or tasks. Optimisation algorithms based on multimodal redundancy and the alignment of cognitive and motor skill with the system capabilities may be used to increase recognition efficiencies.

In any event the invention may make use of target selection mechanisms and algorithms to determine the user's selected navigation target.

This invention proposes significant improvements to a user's ability to navigate information in a more natural or comfortable manner by allowing additional modalities arising from body gestures, including head, hand and eye movements. The additional modalities also provide the user with more choice about how they operate the computer, depending on their level of skill or even mood. The additional modalities may also enable shorter inputs, be it mouse movements voice or gesture, thus increasing efficiency. The invention is able to provide a robust and contextual system interaction, improve noise performance and disambiguate a combination of partial inputs.

The invention has advantages in the following circumstances:

when the user's hands are busy, by making use of body or head gestures;

when the user is away from the keyboard and mouse;

when the user is interacting with a large screen at a distance;

when the user has some kind of disability and can not use keyboard and mouse normally.

In another aspect the invention provides a computer system suitable for use with multimodal navigation of information presentations where the information navigated is not described in a multimodal way; the computer system comprising:

display means to display information presentations to a user;

input means to receive two or more unimodal navigation signals from the user; and

processing means to interpret the two or more unimodal navigations signals and to automatically determine the user's intended navigation selection from a fusion of both interpretations.

In other aspects the invention is a browser, and software to perform the method. The software program may be incorporated into the operating system software of a computer system or into application software.

This invention can also be applied in conjunction with “early binding” mechanisms; and they can be integrated into “early binding” browsers.

### BRIEF DESCRIPTION OF THE DRAWINGS

Some examples of the invention will now be described with reference to the accompanying drawings, in which:

FIG. 1 schematically shows a computer system that can operate in accordance with the invention;

FIG. 2 is a simplified flowchart showing the method of the current invention;

FIG. 3 is a sample information presentation that can by be navigated using the invention;

FIG. 4 shows trajectory based feature selection;

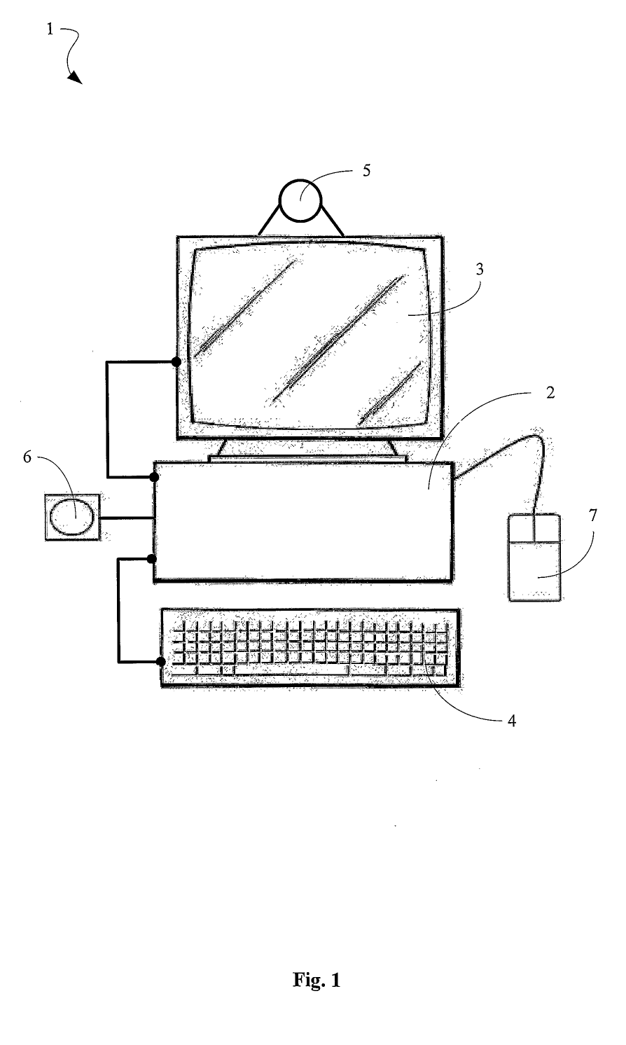

FIG. 1 shows scattered layout selection (with a few relevant links only);

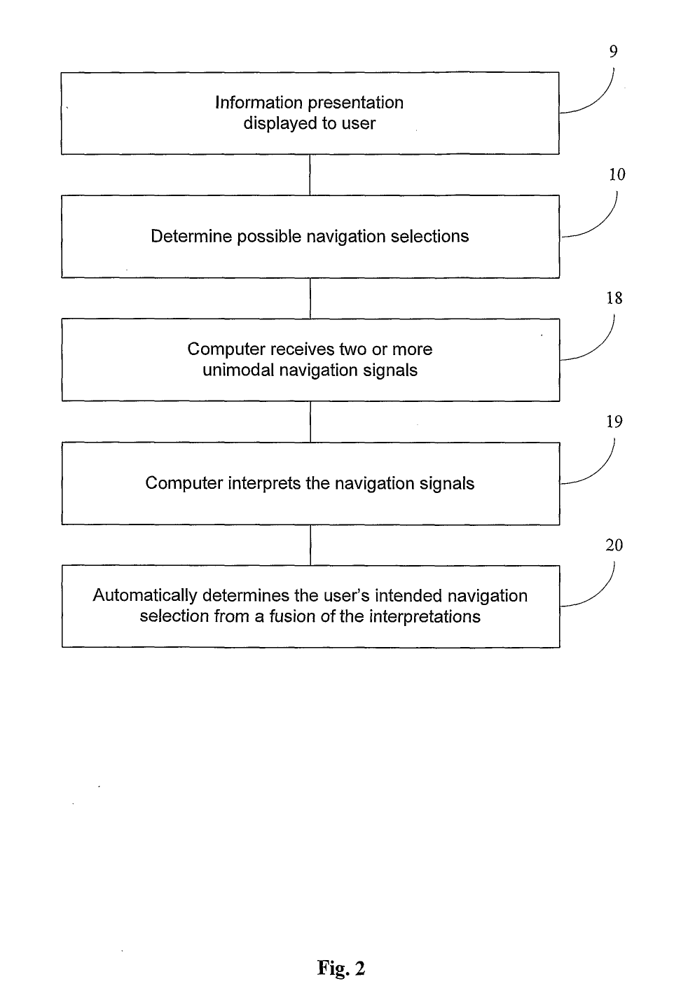

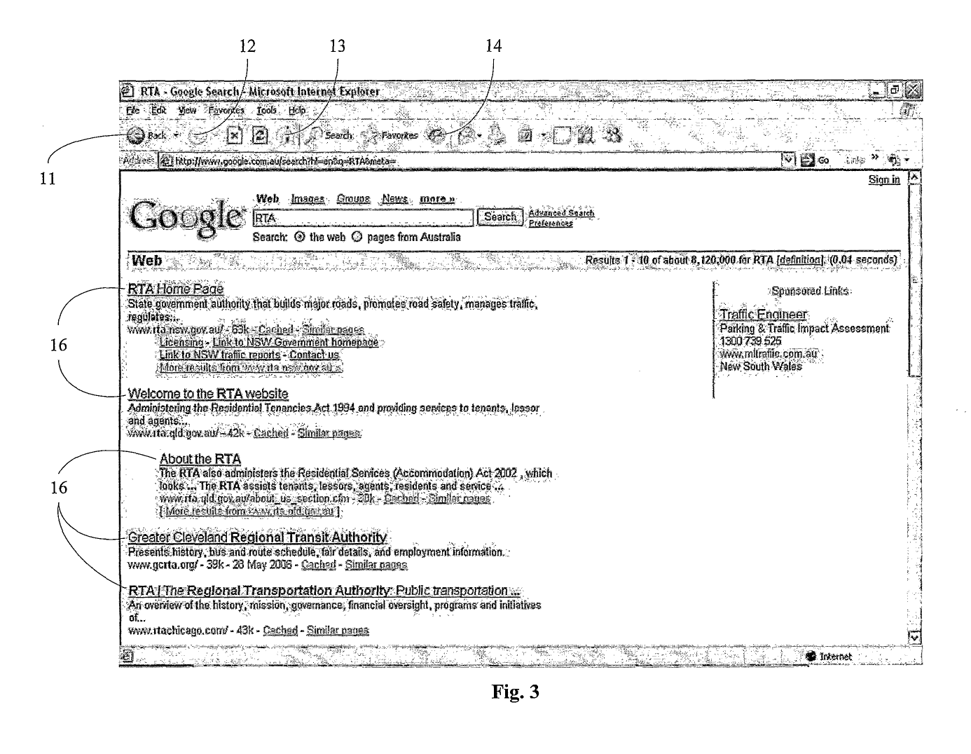

FIG. 2 shows scattered layout selection (with many links);

FIG. 3 shows simplified software architecture for OS level integration and

Fig. shows browser internal changes (event handling).

### BEST MODES OF THE INVENTION

With reference to FIG. 1, there is shown a computer system in the form of a personal computer 1 for multimodal navigation of information presentations. The computer system includes a desktop unit 2 which houses a motherboard, storage means, one or more CPUs and any necessary peripheral drivers and/or network cards, none of which are explicitly shown. Computer 1 also includes a presentation means 3 for presenting information to the user. Also provided are unimodal input means, such as a key board 4, a motion sensor 5, a sound sensor 6 and a mouse 7 for receiving unimodal navigation signals from a user. As would be appreciated by those skilled in the computer art, the CPU includes interpreting means that is able to determine possible navigation selections, interpret and fuse the received navigation signal so as to determine the user's intended navigation selection. For example, the computer system may be a notebook/laptop 1 having an LCD screen 3, a keyboard 4, mouse pointer pad 7 and a video camera 5. The unit 2 includes a processor and storage means and includes software to control the processor to perform the invention.

Information presentations can be either entire displays presented to the user or individual information presentations within the one display. An example of an entire display is information presented in a window, such as an GUI to a database or Microsoft's® Internet Explorer which is a conventional Internet search browser. These displays provide basic navigation capabilities of an entire GUI display such as going from page to page or scrolling through pages (continuously or screen by screen).

An example of individual information presentations within a display is the results of a search or menu screen where for the individual information presentations, one or more navigation selections are available such as a hyperlink to a different display or pop-up box. For example, the result of a browser search that typically produces large lists of structured information containing text, metadata and hyperlinks. Navigation through this material involves the selection and activation of the hyperlinks.

Software is installed on the computer 1 to enable to computer 1 to perform the method of providing a multimodal browser that is able to automatically determine the possible navigation selections that can be selected by the user from an information display, determine a user's intended navigation selection from a fusion of interpretations of more than one inconclusive unimodal navigation inputs. This is achieved by the step of fusing these interpretations.

A method of using the invention for multimodal navigation will now be described with reference to FIG. 2.

Initially, an information presentation as shown in FIG. 3 is displayed 9 to the user on the display means 3 or is at least made available in the storage means 2 of the computer 1 (i.e. processed but not actually displayed). FIG. 3 shows information presented as an entire display (being the browser window) and individual information presentations in form of a hyperlinked list. This is information presentation is not described in a multimodal way. For example, the html source code for this information presentation does not include tags of multimodal marked-up language.

Using the invention the software will operate to determine 10 the possible navigation selections that can be selected by the user from an information display of FIG. 2. This may be done, for example, by:

having knowledge of the how the entire display functions. In this case, the software is aware that the information display is a browser and possible navigation commands include back 11, forward 12, go to the home page 13 or to refresh the current page 14.

extracting hyperlinks 16 within the display. This may include extracting links from the HTML content that are semantically related to navigation, such as “next” or “next page”, which are common in search results (not shown here).

In this way, the software operates to learn about the current information presentation. The learning process may be repeated in whole or in part as the information presented to the user changes. In this way, the software can be retrofitted to any existing software.

In one alternative, the invention may anticipate the user's next navigation selection before the user actually makes the selection. In this way the invention can begin to determine the possible navigation selections of the probable next information presentation.

The list of learnt possible navigation selections may be displayed to the user, such as in a pop-up box or highlighted in the current information presentation, or it may be hidden from the user.

Next the user inputs 18 into the computer 1 two or more unimodal navigation signals using the input devices 4, 5, 6 or 7. These are received by the computer.

Then the computer 2 operates to interprets 19 the received navigations signals. The computer then automatically determines 20 the user's intended navigation selection from a fusion of the interpretations. Based on this, the user's navigation selection is automatically activated and the information presentation is navigated accordingly. Steps 19 and 20 will now be described in further detail.

Some predefined combinations can be made available, such as say “scroll” then tilt your head down to scroll the current page down. The predefined combinations of unimodal navigation signals may be user defined or standard with the software. A user defined combination will take account of the user's skill level, such as motor skill and suitable cognitive load. The combinations can be extended through adaptation to training a recognition module, and by adding new strategies in the fusion module.

### Two Different Types of Fusion are Contemplated:

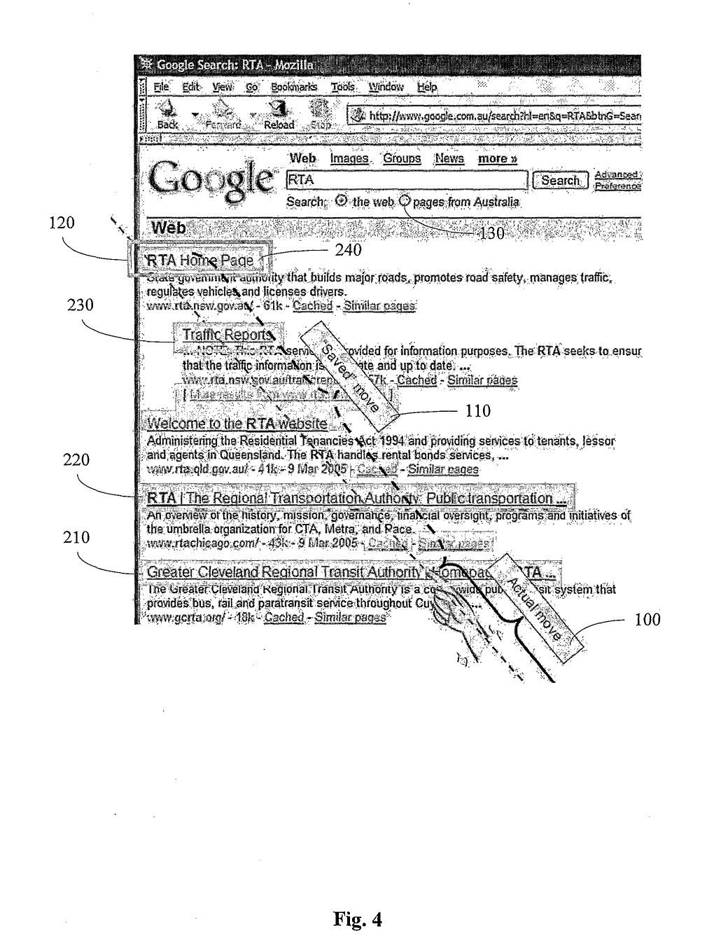

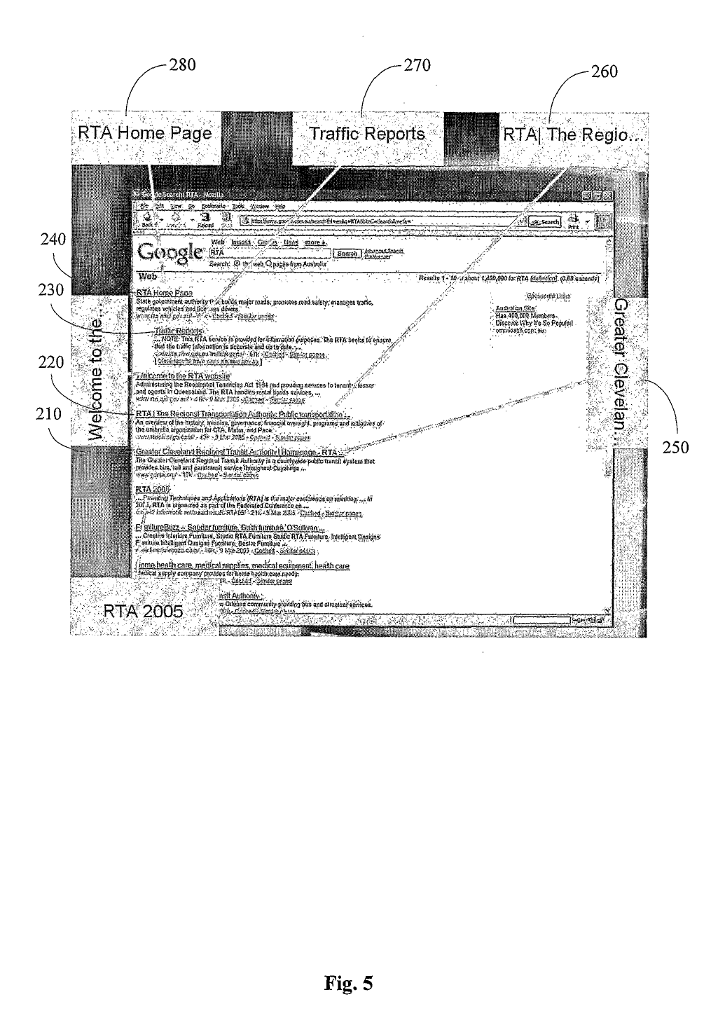

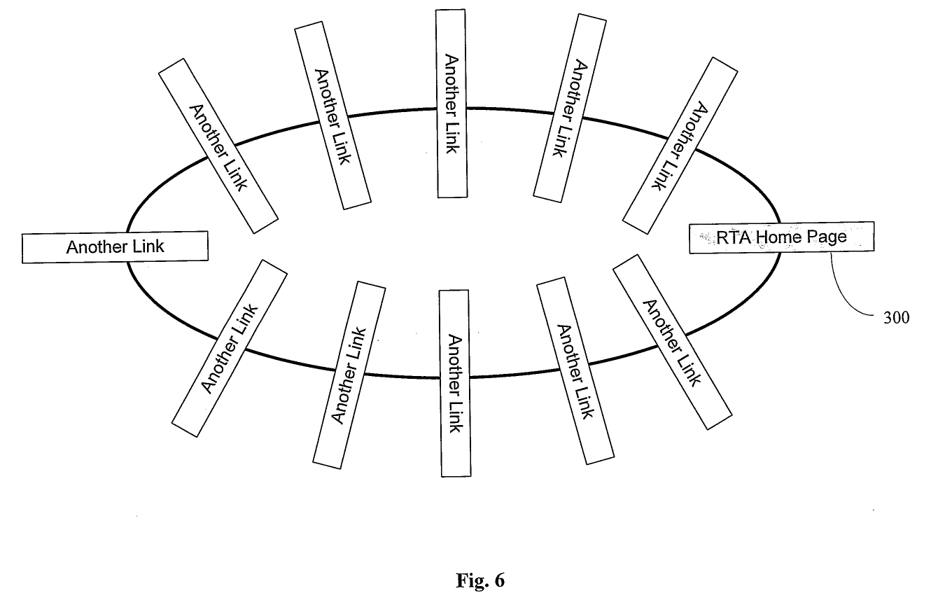

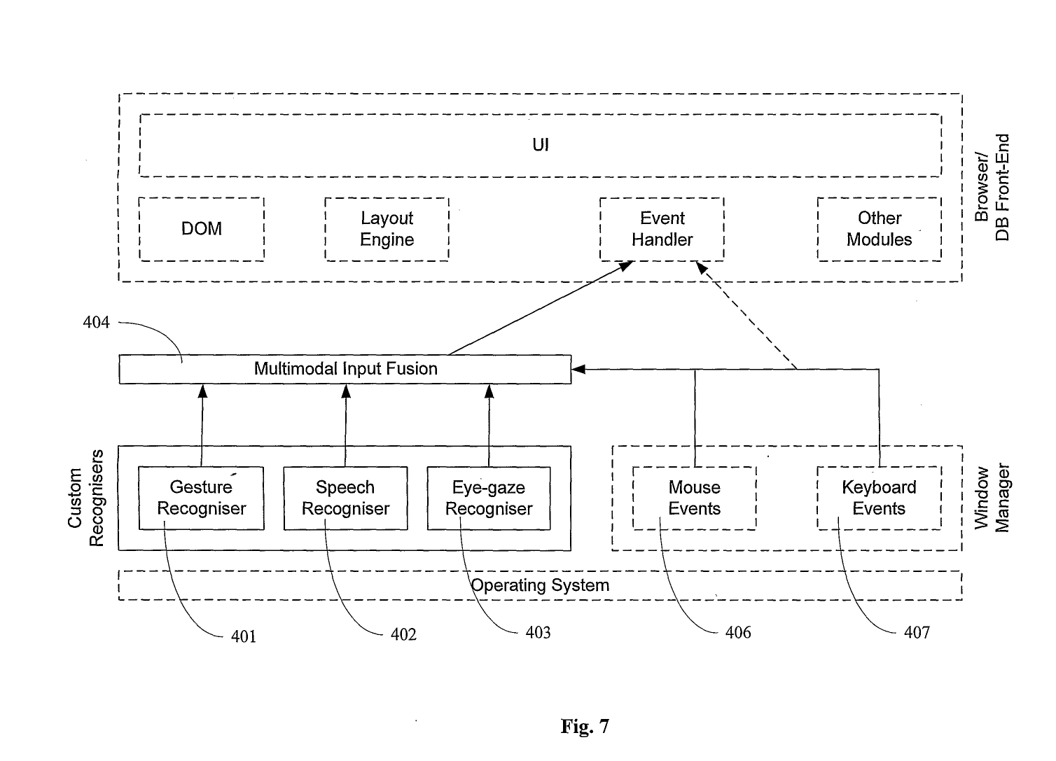

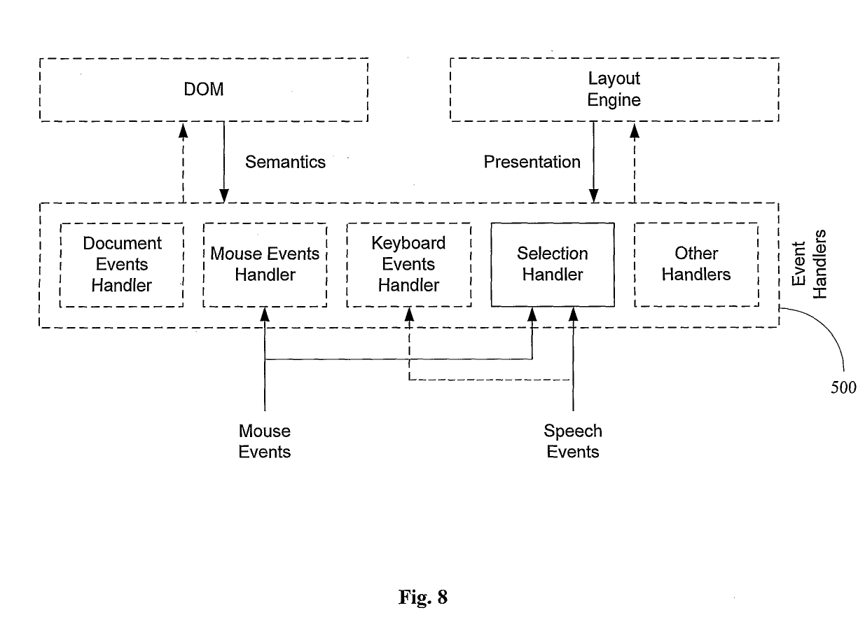

In the example of FIG. 4, the browser shows the result of a Google® search on the input word “RTA”. The page seen is one of many, and contains the results considered most relevant by the Google® search engine. The results are in the form of a list of structured information containing text, metadata and hyperlinks.

A first fusion mechanism exploits the simultaneous combination of two inconclusive interpretations of unimodal navigation inputs to provide a conclusive navigational selection.

The first unimodal navigation input is taken from a hand movement captured by any appropriate transducer such as a mouse or video analysis-based tracking. When the user then starts moving their hand the movement is interpreted and a pointer is moved on the screen accordingly. In FIG. 4 the pointer has moved only a small distance in a straight line as indicated at 100.

In this example the browser also receives an interpreted semantic input via speech recognition software, after the word “Australia” is spoken by the user. The word Australia, or semantic equivalents such as AU, can be found at a number of different locations on FIG. 4 including in the first result RTA Home Page 120 and in the Google® banner at 130.

Fusion involves extrapolating the trajectory of the pointer by capturing the trajectory of its movement along line 100. This involves calculation of the direction, speed and acceleration of the pointer as it moves along line 100. The result of the extrapolation is a prediction that the future movement of the mouse is along the straight line 110. This future movement passes through a number of the search results (in this example all of those which are visible).

The fusion mechanism further involves the combination of these interpretations to unambiguously identify the first result RTA Home Page 120 as the users selection since it is the only visible search result that both lies on line 110 and involves the word “Australia”.

The fusion mechanism results in the hyperlink www.rta.nsw.gov.au/ being automatically activated.

If the user utters the words “Traffic” or “Transport” there are a number of possible destinations along line 110 which could result from the fusion; these are indicated at 210, 220, 230 and 240. In this case the second fusion mechanism will work more effectively.

In the second fusion mechanism a first input is interpreted and the browser then reacts in some manner to that interpretation. A second input is then made and interpreted to provide an unambiguous selection.

In this example the browser first receives the semantic input via speech recognition software, that is the word “traffic”. This word is interpreted and found at locations including 210, where the word traffic is recognised in RTA, 220, 230 and 240.

The browser reacts by displaying scattered tabs 250, 260, 270 and 280 related to respective locations 210, 220, 230 and 240 as shown in FIG. 5.

The result is that the features appear more distinctly, with bigger font, special background and well separated locations. This reduces the cognitive load for the user acquiring the information, but also allows for coarse gesture selection, such as a head gesture, to identify a specific user selection. Such a coarse movement is easy to detect, yet avoids using the mouse or any ambiguity that can arise from speech input. A head gesture recognition software module is used for processing the gesture input.

In this way the second fusion mechanism matches the user's cognitive and motor capabilities against the system limitations by sequentially interpreting and responding to different unimodal inputs.

If a greater number of links are found, direct head gesture based on “absolute” angles is not is not sufficiently accurate, but a circular or rotating gesture can be used to move through a list such as that shown in FIG. 2. One option is to move the highlighted feature according to the head movements; another is to rotate the entire list, leaving the highlighted feature at the same position 300.

In one implementation of the second fusion mechanism, speech is used to select the type of action to be undertaken and gesture provides the parameter of the action.

### Two Types of Integration are Possible:

Operating System (OS) Level Integration

The multimodal navigation technology could be integrated at the OS level, by introducing the fusion capability at the OS event-management level. Multimodal inputs are converted into semantically equivalent uni- or multi-modal outputs to the resident applications. An example is provided by the Microsoft Windows® speech and handwriting recognition which converts speech or hand written inputs into text. Such an implementation requires a good level of control of the OS, and is not very flexible in that the same commands should be applicable to any application. Its strength is to apply to any application without delay.

FIG. 7 shows a simplified view of integration at the operating system level. Existing technology is denoted by dashed boxes. The new features are denoted by solid boxes and lines, and adds recognisers 401, 402 and 403 on top of the operating system. These recognisers feed into a Multimodal Input Fusion module 404 which also intercepts the mouse 406 and keyboard 407 events.

Once the fusion has occurred, the Multimodal Input Fusion module 404 generates outputs to the event handler that are “equivalent” to mouse events or keyboard events—that is the user's navigation selection.

Web Browser or Database (DB) Front-End Integration

This consists in extending a web browser or creating a proprietary front-end for a database. Mainstream browsers such as Mozilla™ offer a comprehensive application interface (API) so that proprietary code can be created to allow application specific integration. The code can handle the multimodal inputs directly as well as access the current information semantics, or Document Object Model (DOM), and the presentation or layout.

FIG. 8 shows how a new event handler 500 can provide such a functionality. Event handler 500 receives mouse and speech events. Gestures can be converted into mouse events as in FIG. 7. By using the internal status of the information, both semantics and presentation, the appropriate actions are triggered, such as following a hyperlink after a trajectory and speech aiming at that link.

Implementing the scattered view imposes modifications into the layout as well as the user interface inside the browser.

Link extraction from the HTML content will detect words semantically related to navigation, such as “next” or “next page”, which are common in search results. User inputs can then be mapped back to those links and allow their selection and opening. This procedure can be generalised by using more complex Natural Language Understanding (NLU) techniques.

In parallel, an acceleration-sensitive gesture input module will be integrated into the browser to capture the direction and acceleration of gestures, and the implementation of the trajectory-based feature.

### INDUSTRIAL APPLICABILITY

The invention could be used in a range of navigation applications, where navigation is understood as conveying (essentially by way of visual displays) pieces of information and allowing the user to change the piece of information viewed in a structured way: back and forward movements, up and down inside a multi-screen page, hyperlink selection and activation, possibly content-specific moves such as “next/previous chapter” etc.

The main domain of application is for web browsing (in the current definition of the web, i.e. essentially HTML-based languages) as well as database and search result browsing, possibly via proprietary front-end applications. This technology should remain beneficial with forthcoming mark-up languages such as X+V given that simple conflict resolution methods are provided. X+V is a W3C proposal draft describing a multimodal mark-up language based on XHTML+VoiceXML. In this schema, multimodal tags must accompany the content from generation (“early binding”) and require specific browsers to be conveyed.

Although the invention has been described with reference to particular examples it should be appreciated that it can be implemented in many other ways. In particular it should be appreciated that the “scattering” of search results as shown in FIGS. 5 and 6 can be used with other unimodal input interpretations as well as the trajectory extrapolation of FIG. 4. Also it should be appreciated that there may be fusion of many unimodal navigation signals.

1. A method for multimodal computer navigation, suitable for navigating information presentations where the information navigated is not described in a multimodal way; the method comprising the steps of:
receiving unimodal navigation signals from a user;
receiving other unimodal navigation signals from the user;
interpreting the navigation signals;
interpreting the other navigation signals; and
automatically determining the user's intended navigation selection from a fusion of both interpretations.

2. A method according to claim 1, wherein one of the unimodal navigation signals is generated from a conventional input device.

3. A method according to claim 2, wherein the other unimodal navigation signals is generated from speech or a body gesture.

4. A method according to claim 3, wherein the body gestures include movements of the head, hand and other body parts such as eyes.

5. A method according to claim 3, wherein the body gestures are captured by analysing video, or from motion transducers worn by the user.

6. A method according to claim 1, the method further comprising the step of predefining fusions of unimodal signals that form a navigation selection.

7. A method according to claim 6, wherein personal or task oriented profiles are created for particular users or tasks.

8. A method according to claim 1, the method further comprising determining the possible navigation selections that could be selected by the user for the information presentation.

9. A method according to claim 8, wherein the step of determining the possible navigation selections is repeated for every information presentation that is displayed to the user.

10. A method according to claim 1, wherein the information presentation is a graphical display of information and the user's selected navigation is either navigation of the entire display or of a smaller information presentation within the information presentation.

11. A method according to claim 1, comprising the further step of learning and adapting to a particular user.

12. A method according to claim 1, wherein fusion involves generating some combination of the interpretations, and using a resulting combination signal to make the automatic determination.

13. A method according to claim 1, wherein fusion involves sequential consideration of interpretations of transducer generated and body gesture navigation signals.

14. A method according to claim 13, comprising the further step of responding to an earlier inconclusive interpretation in some way before receiving or taking account of a later inconclusive interpretation.

15. A method according to claim 14, wherein the responding step involves changing the display and then receiving further unimodal navigation signals from a user to form a conclusive interpretation.

16. A computer system suitable for use with multimodal navigation of information presentations where the information navigated is not described in a multimodal way; the computer system comprising:
display means to display information presentations to a user;
input means to receive two or more unimodal navigation signals from the user; and
processing means to interpret the two or more unimodal navigations signals and to automatically determine the user's intended navigation selection from a fusion of both interpretations.

17.-27. (canceled)

28. A computer browser programmed to perform the method of claim 1.

29. A software program to perform the method of claim 1.

30. A software program according to claim 29, wherein the software program is incorporated with the operating system software of a computer system.

31. A software program according to claim 29, wherein the software program is incorporated with application software.

32. A computer system programmed to perform the method of claim 1.

33. A method according to claim 1, wherein one of the unimodal navigation signals is generated from body gestures, and the other unimodal signals is generated from speech of the user.

34. A method according to claim 33, wherein the step of automatically determining the user's intended navigation selection from a fusion of both interpretations comprises identifying the navigation selections within the information presentation and on a determined extended trajectory in the direction of the body gesture and selecting the navigation selection that passes through the trajectory that is described by the speech of the user.

35. A method according to claim 34, wherein the step of determining the trajectory further comprises moving a pointer within the information presentation along the trajectory.

36. A method according to claim 34, wherein the method further comprises the initial step of determining all the possible navigation selections that could be selected by the user for the information presentation.
